(19) United States
(12) Patent Application Publication
(10) Pub. No.: US 2003/0115588 A1
(43) Pub. Date: Jun. 19, 2003

(54) Broadcasting signal processing apparatus

(76) Inventor: Hironobu Hoshino, Kawagoe-shi (JP)

Correspondence Address: SUGHRUE MION, PLLC, 2100 PENNSYLVANIA AVENUE, N.W., WASHINGTON, DC, 20037, US

(21) Appl. No.: 10/333,981

(22) PCT Filed: Aug. 3, 2001
(86) PCT No.: PCT/JP01/06696

(30) Foreign Application Priority Data
Aug. 4, 2000 (JP) 2000-237236

(51) Int. Cl. H04N 7/16; H04H 9/00

(52) U.S. Cl. 725/9

(57) ABSTRACT

The broadcasting signal processing apparatus has tuners, a distribution section for distributing a received broadcasting signal to at least one of the tuners, a receiving state detecting section for detecting a receiving state of the received broadcasting signal, and a control section for determining the number of tuners, to which the broadcasting signal is distributed, based on the detected receiving state. To avoid a loss caused by the distribution section, the apparatus distributes the broadcasting signal to only one tuner, for example, when the receiving state is inferior.

### BACKGROUND OF THE INVENTION

1. Field of the Invention

This invention relates to a technical field of a broadcasting signal processing apparatus. More specifically, the invention relates to a technical field of a broadcasting signal processing apparatus which is provided with a plurality of signal processing sections for giving a predetermined process to a broadcasting signal corresponding to broadcasting obtained from an external source.

2. Description of the Related Art

In recent years, new communication lines such as a satellite communication line or a ground wave digital line have spread widely.

As a receiver receiving television programs and radio programs which are broadcasted as broadcasting electronic waves or receiving data broadcasting for computers via these lines, the following receiver is used. Such a receiver is constituted so that broadcasting signals corresponding to the broadcasting electronic waves received via one antenna are distributed to a plurality of receiving sections, and different receiving processes are executed in the receiving sections. More concretely, for example, the television program is extracted from the broadcasting electronic wave in one receiving section so as to be displayed on a display or the like, the radio program is extracted from the broadcasting electronic wave in another receiving section so as to be output to an amplifier or the like, and the data broadcasting is extracted from the broadcasting electronic wave in the other receiving section so as to be output to a computer or the like.

The receiver is constituted so that the broadcasting signal corresponding to the received broadcasting electronic wave is always distributed to all the receiving sections uniformly.

However, in the above-mentioned conventional receiver, since the broadcasting signals are always distributed to all the receiving sections, in a poor receiving environment such that electric field strength or the like of the received broadcasting electronic wave is insufficient, an electric power to be distributed to one receiving section is weakened due to existence of the other receiving sections even if its electric field strength is such that a sufficient receiving process can be executed in only one receiving section. As a result, there arises a problem that the receiving process cannot be executed in all the receiving sections.

In digital broadcasting which has been developed actively, when a receiving electric power is not more than a preset constant electric power, an image and a sound corresponding to the received broadcasting electric wave cannot be decoded at all. For this reason, the above-mentioned problem which arises when the broadcasting signal is always distributed to all the receiving sections is further elicited.

### SUMMARY OF THE INVENTION

The present invention is devised in order to solve the above problems and it is an object of the present invention to provide a broadcasting signal processing apparatus in which even if receiving strength is lowered, namely, a receiving state of a broadcasting electronic wave is deteriorated, a receiving process can be executed on the broadcasting signal in any one of receiving sections.

The above object of the present invention can be achieved by a broadcasting signal processing apparatus of the present invention. The apparatus is provided with: a plurality of signal processing devices for giving a predetermined process to a broadcasting signal; a distributing device for distributing the broadcasting signal obtained from outside to at least one of said plurality of signal processing devices; a detecting device for detecting an obtaining state of the broadcasting; and a determining device for controlling the distributing device and for determining at least one of said plurality of signal processing devices based on the detected obtaining state.

According to the present invention, since the signal processing device to be the distributing destination is determined based on the broadcasting obtaining state, in comparison with the case where the broadcasting signal is always distributed to all the signal processing devices, the processes in the respective signal processing devices are prevented from being impossible due to deterioration of the obtaining state of broadcasting. Moreover, the process in one of signal processing devices is enabled even in the inferior broadcasting obtaining state.

In one aspect of the present invention, the determining device compares the obtaining state of the broadcasting with a predetermined value, which is a threshold value to change the number of signal processing devices, to which the broadcasting signal is distributed by the distributing devices.

According to this aspect, since the actual obtaining state of broadcasting is compared with the preset lowest obtaining state and the signal processing device to be the distributing destination is determined, the signal processing device to be the distributing destination can be determined simply and securely.

In another aspect of the present invention, the determining device determines at least one of said plurality of signal processing devices further based on an order of priority in the plurality of signal processing devices.

According to this aspect, the signal processing device to be the distributing destination can be determined based on the priorities efficiently and effectively.

The above object of the present invention can be achieved by a broadcasting signal processing apparatus of the present invention. The apparatus is provided with: a plurality of signal processing devices for giving a preset process to a broadcasting signal; a distributing device for distributing the broadcasting signal obtained from outside to at least one of said plurality of signal processing devices; a detecting device for detecting an obtaining state of the broadcasting; and a determining device for controlling the distributing device and for determining the number of the signal processing devices, to which the broadcasting signal is distributed by the distributing device.

According to the present invention, since the number of the signal processing devices to be the distributing destinations is determined based on the obtaining state of broadcasting, in comparison with the broadcasting signal is always distributed to all the signal processing devices, the processes in the respective signal processing devices are prevented from being impossible due to deterioration of the obtaining state of broadcasting. Moreover, the process in one of signal processing devices is enabled even in the inferior obtaining state of broadcasting.

In one aspect of the present invention, the determining device compares the obtaining state of the broadcasting with a predetermined value, which is a threshold value to change the number of signal processing devices.

According to the present invention, since the actual obtaining state of broadcasting is compared with the preset lowest obtaining state and the number of the signal processing devices to be the distributing destinations is determined, the number can be determined simply and securely.

In another aspect of the present invention, the determining device determines the number of the signal processing devices, further based on an order of priority in the plurality of signal processing devices.

According to the present invention, the number of the signal processing devices to be the distributing destinations can be determined based on the priorities efficiently and effectively.

In further aspect of the present invention, the distributing device distributes the broadcasting signal while obtaining impedance matching according to the number of the signal processing devices.

According to the present invention, the broadcasting signal can be distributed while attenuation of the signal level in the broadcasting signal is minimum.

In further aspect of the present invention, when the obtaining state is worse obtaining state than a predetermined level, the determining device determines only one of said plurality of signal processing devices so that distributing device distributes the broadcasting signal only to the one of said plurality of signal processing devices.

According to this aspect, the process in one signal processing device for the broadcasting signal can be executed securely.

In further aspect of the present invention, the predetermined process includes a receiving process of the broadcasting signal, and the obtaining state is at least any one of a receiving electric power of the broadcasting signal, an error rate in the broadcasting signal, and a C/N ratio of the broadcasting signal.

According to the present invention, since at least any one of the receiving electric power and the error rate of broadcasting is used, the signal processing device to be the distributing destination or the number can be determined securely.

In further aspect of the present invention, the broadcasting is obtained via at least any one of a broadcasting electronic wave, a cable television line, and an internet line.

According to the present invention, the corresponding process can be executed on a broadcasting electronic wave corresponding to broadcasting obtained via at least one of the broadcasting electronic wave, the cable television line and the internet line in one of signal processing devices.

### BRIEF DESCRIPTION OF THE DRAWINGS

FIG. 1 is a block diagram showing a schematic configuration of a receiving apparatus according to the first embodiment of the present invention;

FIG. 2 is a graph diagram showing a relationship between an input level and an error rate in the receiving apparatus according to the first embodiment;

FIG. 3 is a block diagram showing a schematic configuration of a receiving apparatus according to the second embodiment of the present invention;

FIG. 4A is a graph diagram showing a relationship between an input level and an AGC voltage in the receiving apparatus according to the second embodiment;

FIG. 4B is a diagram showing a relationship between a modulating method and an AGC threshold voltage in the receiving apparatus according to the second embodiment;

FIG. 5 is a block diagram showing a schematic configuration of a receiving apparatus according to the third embodiment of the present invention; and

FIG. 6 is a circuit block diagram showing a configuration of a distribution section according to a modified embodiment of the present invention.

### DETAILED DESCRIPTION OF THE PREFERRED EMBODIMENTS

There will be explained below the preferred embodiments of the present invention with reference to the drawings.

The following embodiments explains the case where the present invention is applied to a receiving apparatus which receives a broadcasting electronic wave broadcasted on the basis of the terrestrial integrated services digital broadcasting (ISDB-T) system which is one of digital broadcasting systems actively developed in recent years and demodulates the broadcasting electronic wave.

(I) First Embodiment

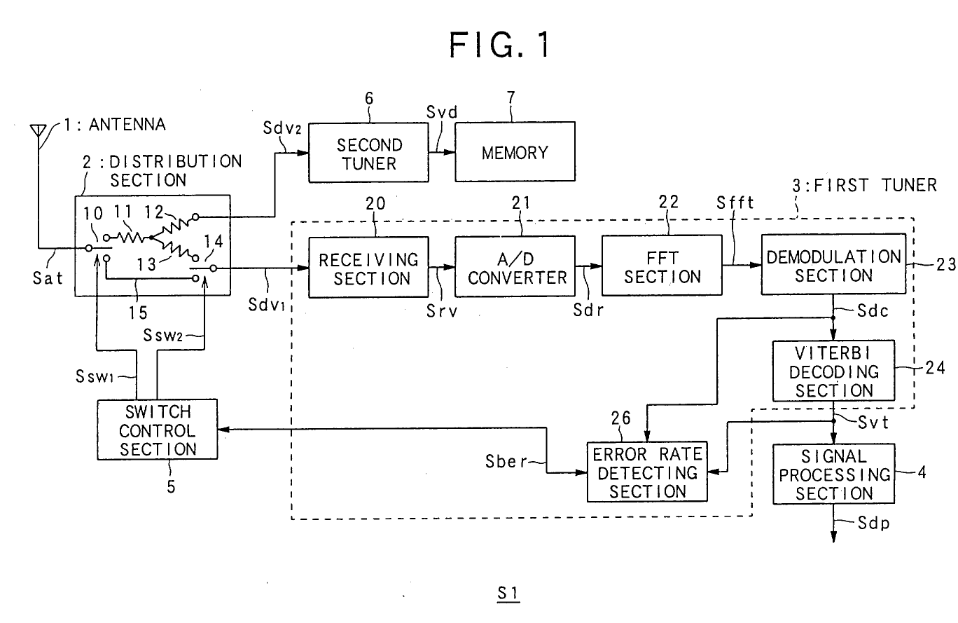

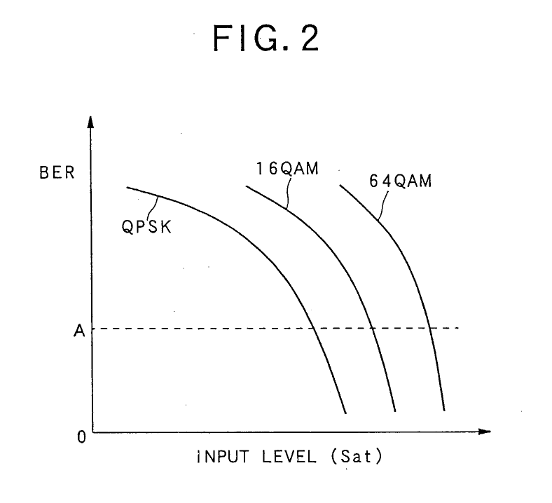

At first, there will be explained below the first embodiment of the present invention with reference to FIGS. 1 and 2.

FIG. 1 is a block diagram showing a schematic configuration of the receiving apparatus according to the first embodiment, and FIG. 2 is a diagram explaining an operation of the receiving apparatus. Moreover, in the first embodiment, for simplifying description, the description will be given as to a case where a resistance distribution section having simple configuration is used as a distribution section, mentioned later.

As shown in FIG. 1, a receiving apparatus S1 of the first embodiment is composed of an antenna 1, a distribution section 2 as a distributing device, a first tuner 3 as a signal processing device, a signal processing section 4, a switch control section 5 as a determining device, a second tuner 6 as a signal processing device, and a memory 7.

In addition, the distribution section 2 is composed of switches 10 and 14, resistors 11 through 13 having preset resistance values, and a connection line 15.

Further, the first tuner 3 is composed of a receiving section 20, an A/D (Analog/Digital) converter 21, an FFT (Fast Fulier Transfer) section 22, a demodulating section 23, a Viterbi decoding section 24, and an error rate detecting section 26 as a detecting device.

Next, there will be explained below an operation of the receiving apparatus.

In the following explanation, besides a broadcasting electronic wave as television broadcasting, a broadcasting electronic wave as data broadcasting (namely, data broadcasting in which data to be used in a computer or the like are broadcasted via a broadcasting electronic wave) is multiplexed on a broadcasting electronic wave to be received.

The antenna 1 receives a broadcasting electronic wave broadcasted on the basis of the ISDB-T system, and generates a broadcasting signal Sat to output it to the distribution section 2.

The distribution section 2 executes one of a first distribution process and a second distribution process. The first distribution process outputs a broadcasting signal Sat as a distribution signal Sdv1 only to the first tuner 3 based on switch control signals Sw1 and Sw2 from the switch control section 5. The second distribution process outputs the broadcasting signal Sat as the distribution signal Sdv1 to the first tuner 3 and outputs the broadcasting signal Sat as a broadcasting signal Sdv2 to the second tuner 6.

In the case where the first distribution process is executed, the switches 10 and 14 are turned to the connection line 15 side based on the switch control signals Ssw1 and Ssw2 respectively so that the broadcasting signal Sat is directly output as the distribution signal Sdv1 to the first tuner 3.

Meanwhile, in the case where the second distribution process is executed, the switches 10 and 14 are turned respectively to the sides of the resistors 11 and 13 based on the switch control signals Ssw1 and Ssw2 so that the broadcasting signal Sat is output as the distribution signal Sdv1 and the distribution signal Sdv2 to the first tuner 3 and the second tuber 6 in the distribution ratio (normally, the same values) corresponding to resistance values of the resistors 11 through 13.

As a result, only in the case where the second distribution process is executed, the second tuner 6 extracts data information corresponding to the data broadcasting included in the distribution signal Sdv2, and gives a preset demodulating process to the extracted data information and generates a data demodulation signal Sdv so as to output it to the memory 7.

The demodulating process in the second tuber 6 is executed in the same frequency band as a demodulating process, mentioned later, executed in the first tuner 3.

The memory 7 stores contents of the data information included in the data demodulation signal Sdv. Thereafter, the stored data information is used for a display process of character information and predetermined processes in a computer.

On the other hands, in the case where the first distribution process and the second distribution process are executed, the receiving section 20 into which the distribution signal Sdv1 is input executes a receiving process such as a wave shaping process preset for the distribution signal Sdv1 and extracts a component corresponding to the television broadcasting from the distribution signal Sdv1 after the receiving process so as to output the component as a receiving signal Srv to the A/D converter 21.

The A/D converter 21 executes a digitizing process on the receiving signal Srv as an analog signal so as to generate a digital receiving signal Sdr and output this signal to the FFT section 22.

Next, the FFT section 22 executes a frequency spectrum analyzing process and a frequency dividing process on the digital receiving signal Sdr, and outputs an FFT signal Sfft to the demodulating section 23.

As a result, the demodulating section 23 executes a demodulating process preset for each divided frequency included in the FFT signal Sfft so as to generate a demodulation signal Sdc and outputs this signal to the Viterbi decoding section 24 and the error rate detecting section 26.

The Viterbi decoding section 24 executes an error correcting process and a decoding process on the demodulation signal Sdc according to the well-known Viterbi decoding system, and outputs this signal as a decoding signal Svt to the signal processing section 4 and the error rate detecting section 26.

As a result, the signal processing section 4 executes a preset wave shaping process or an amplifying process conforming to the television broadcasting on the component corresponding to the television broadcasting included in the decoding signal Svt, and generates a processing signal Sdp including image and sound broadcasted as the television broadcasting so as to output this signal to a television device (not shown).

Thereafter, various signal processes are executed in the television device, and the image is displayed on a display of the television device, and the sound is output from a speaker of the television device.

Meanwhile, the error rate detecting section 26 compares the demodulation signal Sdc with the decoding signal Svt which has error-corrected, and detects an error rate (BER (Bit Error Rate)) of the demodulation signal Sdc and generates a rate signal Sber showing the detected BER so as to output it to the switch control section 5.

As a result, the switch control section 5 generates the switch control signals Ssw1 and Ssw2 and outputs them to the switches 10 and 14 so that any one of the first distribution process and the second distribution process is executed in the distribution section 2 based on the rate signal Sber.

Next, there will be detailed below the distribution process in the distribution section 2 based on a control process by means of the switch control section 5 of the present invention with reference to FIGS. 1 and 2.

As mentioned above, the switch control section 5 allows the distribution section 2 to execute any one of the first distribution process and the second distribution process based on the rate signal Sber.

Namely, as shown in FIG. 2, when it is determined on the basis of the rate signal Sber that BER shown by the rate signal Sber is less than a preset threshold “A” regardless of a carrier modulation system in the ISDB-T system, the switch control section 5 generates the switch control signals Ssw1 and Ssw2 and outputs them to the switches 10 and 14 so that the second distribution process is executed. In this case, even if the broadcasting signal Sat is distributed to both the first tuner 3 and the second tuber 6, the demodulating processes in the respective tuners are normally executed.

Meanwhile, in the case it is determined that BER shown by the rate signal Sber is not less than the threshold “A”, the switch control section 5 generates the switch control signals Ssw1 and Ssw2 and outputs them to the switches 10 and 14 so that the first distribution process is executed and the broadcasting signal Sat is distributed only to the first tuner 3. In this case, if the broadcasting signal Sat is distributed to both the first tuner 3 and the second tuner 6, the demodulating processes in the respective tuners cannot normally executed.

The threshold “A” is previously and experimentally obtained as a minimum value of BER in which the normal demodulating processes cannot be executed in the case where the broadcasting signal Sat is distributed to both the first tuner 3 and the second tuner 6. More concretely, in the case where any one of a QPSK (Quadrature Phase Shift keying) system, a 16QAM (16 Quadrature Amplitude Modulation) system and a 64 QAM system is used as the carrier modulation system, for example, the threshold “A” is set as BER corresponding to the case where two errors are included in 10,000 items of data at the stage of the demodulation signal Sdc.

As explained above, according to the distribution process in the receiving apparatus S1 of the first embodiment, it is determined which distribution process is executed, on the basis of a receiving state of broadcasting electronic wave. In other words, the number of distributing destinations is determined. Therefore, in comparison with the case where the broadcasting signal Sat is always distributed to all tuners, the receiving processes in the respective tuners can be prevented from being impossible due to deterioration of the receiving state. Moreover, the receiving process in the first tuner 3 is enabled even in an inferior receiving state of broadcasting electronic wave.

In addition, since actual BER is compared with the preset threshold “A” so that a form of the distribution process is determined, the distribution process can be executed simply and securely.

Further, since the form of the distribution process is determined on the basis of preset priorities in the respective tuners (in the case of the first embodiment, the first tuner 3 has a higher priority than the second tuner 6), the distributing destination of the broadcasting signal Sat can be determined efficiently and effectively based on the priorities.

Furthermore, when the detected actual BER is not less than the threshold “A”, the broadcasting signal Sat is distributed only to the first tuner 3. Therefore, distribution of the broadcasting signal Sat to the second tuner 6 is stopped, and thus a signal level of the broadcasting signal Sat to be distributed to the first tuner 3 increases. As a result, a noise level of the broadcasting signal Sat to be distributed to the first tuner 3 is reduced, and a receivable state in the first tuner 3 can be continued.

In addition, since the broadcasting signal Sat is distributed only to the first tuner 3 only via the connection line 15 excluding a resistor, a loss of the broadcasting signal Sat in the resistors is reduced. Therefore, the broadcasting electronic wave can be continuously received in a satisfactory receiving state.

(II) Second Embodiment

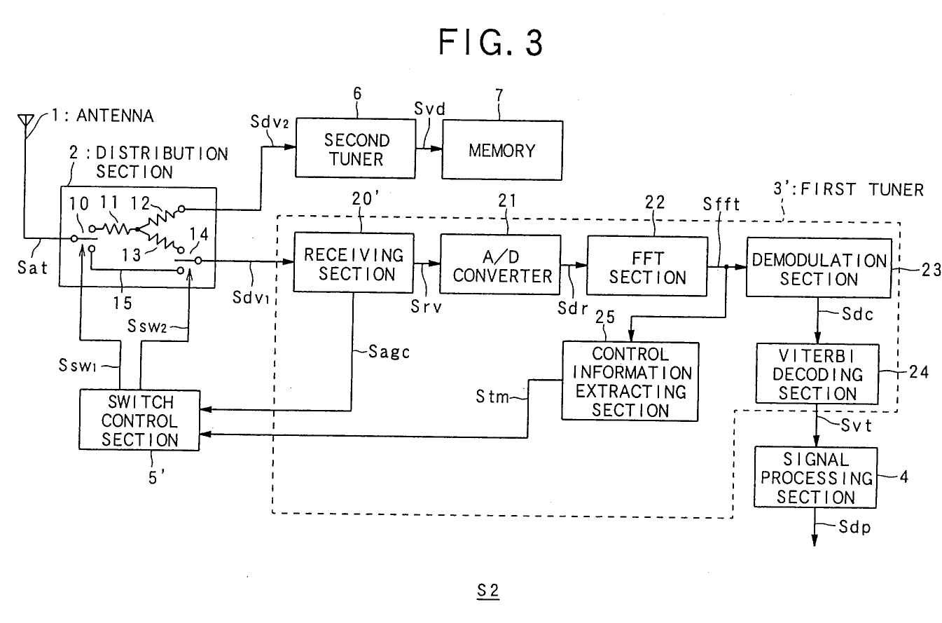

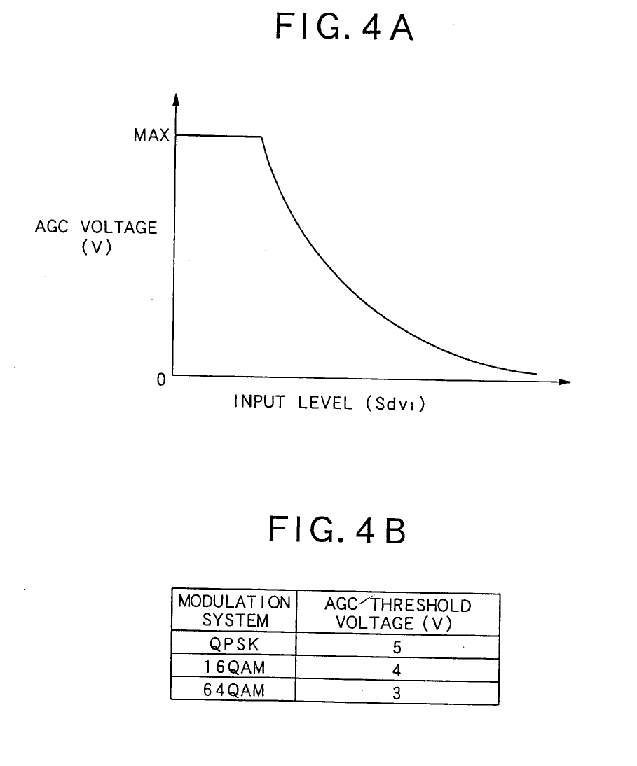

There will be explained below the second embodiment as another embodiment of the present invention with reference to FIGS. 3 and 4.

FIG. 3 is a block diagram showing a schematic configuration of the receiving apparatus according to the second embodiment, and FIG. 4 is a diagram explaining an operation of the receiving apparatus.

In addition, in FIG. 3, the same reference numerals are given to the same members as the receiving apparatus S1 of the first embodiment shown in FIG. 1, and the detailed description thereof is omitted.

In the first embodiment, the actual BER is compared with the preset threshold “A” so that the form of the distribution process is determined, but in the second embodiment, the form of the distribution process is determined according to a receiving electric power of the broadcasting electronic wave.

As shown in FIG. 3, a receiving apparatus S2 of the second embodiment is composed of the antenna 1, the distribution section 2, the signal processing section 4, the second tuner 6 and the memory 7 which are the same as those of the receiving apparatus S1 of the first embodiment, and also a first tuner 3′ and a switch control section 5′.

In addition, the first tuner 3′ is composed of the A/D converter 21, the FFT section 22, the demodulating section 23 and the Viterbi decoding section 24 which are the same as those of the first tuner 3 of the first embodiment, and also a receiving section 20′ and a control information extracting section 25.

Next, there will be explained below the operation of the receiving apparatus S2.

In the following description about the operation, similarly to the first embodiment, besides the broadcasting electronic wave as television broadcasting, the broadcasting electronic wave as data broadcasting is multiplexed into the broadcasting electronic wave to be received.

At first, the antenna 1 and the distribution section 2 execute the same processes as the first embodiment, and any one of the first distribution process and the second distribution process is executed so that the distribution signal Sdv1 and the broadcasting signal Sdv2 are generated.

As a result, when the second distribution process is executed, the second tuner 6 and the memory 7 execute the demodulating process and the data information storing process which are the same as those of the first embodiment.

On the other hand, in the case where the first distribution process and the second distribution process are executed, the receiving section 20′ in to which the distribution signal Sdv1 is input generates the receiving signal Srv and outputs it to the A/D converter 21 similarly to the first embodiment. Moreover, the receiving section 20′ generates an AGC signal Sagc showing an AGC voltage set when an AGC (Auto Gain Control) process for automatically controlling an amplifying degree of the receiving signal Srv is executed, and outputs the AGC signal Sagc as a parameter showing the receiving electric power of the broadcasting electronic wave to the switch control section 5′.

More concretely as shown in FIG. 4A, the AGC voltage rises as an input level of the distribution signal Sdv1 is reduced (namely, the receiving electric power of the broadcasting electronic wave is reduced) until the value reaches a preset maximum value MAX.

The A/D converter 21 and the FFT section 22 execute the same processes as the first embodiment, and generate the FFT signal Sfft and output the signal to the demodulating section 23 and the control information extracting section 25.

As a result, the demodulating section 23, the Viterbi decoding section 24 and the signal processing section 4 execute the same processes as the first embodiment, and generate the processing signal Sdp so as to output it to the television device (not shown).

Meanwhile, the control information control section 25 extracts a TMCC (Transmission Multiplexing Configuration Control) signal component from the FFT signal Sfft, and outputs a control information component, which is included as the TMCC signal in the distribution signal Sdv1, as the control information Stm to the switch control section 5′.

The TMCC signal includes various control information according to the ISDB-T system. More concretely, in television broadcasting in conformity with the ISDB-T system, carrier modulating system information, convolutional coding rate information, time interleave length information and segment number information are included as the control information, whereas in radio broadcasting according to the ISDB-T system, in addition to the above information, a format discriminating flag showing a segment format is included as the control information.

As a result, the switch control section 5′ generates the switch control signals Ssw1 and Ssw2 and outputs them to the switches 10 and 14 so as to allow the distribution section 2 to execute any one of the first distribution process and the second distribution process based on the control information Stm and the AGC signal Sagc.

Next, there will be detailed below the distribution process in the distribution section 2 based on the control process by means of the switch control section 5′ of the present invention with reference to FIGS. 3 and 4.

As mentioned above, the switch control section 5′ allows the distribution section 2 to execute any one of the first distribution process and the second distribution process based on the control information Stm and the AGC signal Sagc.

Namely, as shown in FIG. 4B, bases on the carrier modulation system information included in the control information Stm, when it is determined that the carrier modulation system is the QPSK system and the AGC voltage is smaller than 5 V, the switch control section 5′ generates the switch control signals Ssw1 and Ssw2 so as to outputs them to the switches 10 and 14 so that the second distribution process is executed. In this case, even if the broadcasting signal Sat is distributed to both the first tuner 3 and the second tuner 6, the receiving electric power which is enough to execute the demodulation processes in the respective tuners can be obtained.

Meanwhile, when it is determined that the carrier modulation system is the QPSK system and the AGC voltage is not less than 5 V, the switch control section 5′ generates the switch control signals Ssw1 and Ssw2 and outputs them to the switches 10 and 14 so that the first distribution process is executed and the broadcasting signal Sat is distributed only to the first tuner 3. If the broadcasting signal Sat is distributed to both the first tuner 3 and the second tuner 6, the demodulation processes in the respective tuners cannot be normally executed.

In addition, when it is determined that the carrier modulation system is the 16QAM system and the AGC voltage is less than 4 V, the switch control section 5′ generates the switch control signals Ssw1 and Ssw2 and outputs them to the switches 10 and 14 so that the second distribution process is executed. In this case, even if the broadcasting signal Sat is distributed to both the first tuner 3 and the second tuner 6, the receiving electric power which is enough to normally execute the demodulation processes in the respective tuners can be obtained.

Meanwhile, when it is determined that the carrier modulation system is the 16QAM system and the AGC voltage is not less than 4 V, the switch control section 5′ generates the switch control signals Ssw1 and Ssw2 and outputs them to the switches 10 and 14 so that the first distribution process is executed and the broadcasting signal Sat is distributed only to the first tuner 3. If the broadcasting signal Sat is distributed to both the first tuner 3 and the second tuner 6, the demodulation processes in the respective tuners cannot be normally executed.

Further, when it is determined that the carrier modulation system is the 64QAM system and the AGC voltage is less than 3 V, the switch control section 5′ generates the switch control signals Ssw1 and Ssw2 and outputs them to the switches 10 and 14 so that the second distribution process is executed. If the broadcasting signal Sat is distributed to both the first tuner 3 and the second tuner 6, the receiving electric power which is enough to normally execute the demodulation processes in the respective tuners can be obtained.

Meanwhile, when it is determined that the carrier modulation system is the 64QAM system and the AGC voltage is not less than 3 V, the switch control section 5′ generates the switch control signals Ssw1 and Ssw2 and outputs them to the switches 10 and 14 so that the first distribution process is executed and the broadcasting signal Sat is distributed only to the first tuner 3. If the broadcasting signal Sat is distributed to both the first tuner 3 and the second tuner 6, the demodulation processes in the respective tuners cannot be normally executed.

The AGC threshold voltage is previously and experimentally obtained for each carrier modulating system taking a receiving process ability or the like in the first tuner 3 and the second tuner 6 into consideration.

As mentioned above, according to the distribution process in the receiving apparatus S2 of the second embodiment, based on the receiving electric power of the broadcasting electronic wave, it is determined which distribution process is executed. In other words, a number of distribution destinations are determined. Therefore, in comparison with the case where the broadcasting signal Sat is always distributed to all the tuners, the receiving processes in the respective tuners can be prevented from being impossible due to deterioration of the receiving electronic power. Moreover, the receiving process in the first tuner 3 is enabled even in the inferior receiving state of broadcasting electronic wave.

In addition, since the AGC voltage as a standard of the actual receiving electronic power is compared with the preset AGC threshold so that the form of the distribution process is determined, the distribution process can be executed simply and securely.

Further, the form of the distribution process is determined on the basis of the preset priorities in the respective tuners (in the case of the second embodiment, the first tuner 3 has a higher priority than the second tuner 6). Therefore, the distribution destinations of the broadcasting signal Sat can be determined efficiently and effectively based on the priorities.

Furthermore, when the detected actual AGC voltage is not less than the AGC threshold voltage, the distribution of the broadcasting signal Sat to the second tuner 6 is stopped. Therefore, the signal level of the broadcasting signal Sat to be distributed to the first tuner 3 increases, and thus the noise level of the broadcasting signal Sat to be distributed to the first tuner 3 is reduced. As a result, the receivable state in the first tuner 3 can be continued.

In addition, since the broadcasting signal Sat corresponds to digital broadcasting and the form of the distribution process is determined by using the AGC receiving voltage, the distribution destinations can be. determined accurately.

Furthermore, since information is obtained via broadcasting electronic wave, the receiving process, which securely conforms to the information obtained via broadcasting electronic wave, can be executed in one of the tuners.

The above-mentioned second embodiment described the case where the AGC voltage in the receiving section 20′ as a parameter showing the receiving electric power of the broadcasting electronic wave is used. Besides this, a C/N (Carrier Noise) ratio is calculated from an actual ratio of a receiving voltage to a noise voltage in the receiving section 20′ at the time of receiving the broadcasting electronic wave so that the switch control section 5 can be operated by using this C/N ratio.

Namely, a lowest receiving C/N ratio, which is calculated according to a combination of the carrier modulation system information and the convolutional coding rate to be input as the control information Stm, is previously calculated, and the lowest receiving C/N ratios for the respective combinations are stored by the switch control section 5′.

Thereafter, a value of a C/N ratio signal showing the C/N ratio input at the time of actually receiving broadcasting electronic wave is compared with the lowest receiving C/N ratio obtained from the carrier modulation system and the convolutional coding rate input as the control information Stm in the switch control section 5′. When the actual C/N ratio is larger than the corresponding lowest receiving C/N ratio, the switch control signals Ssw1 and Ssw2 are generated to be output to the distribution section 2 so that the second distribution process is executed. When the actual C/N is not more than the lowest receiving C/N ratio, the switch control signals Ssw1 and Ssw2 are generated to be output to the distribution section 2 so that the first distribution process is executed.

With such a configuration, the same effect as the second embodiment can be obtained.

(III) Third Embodiment

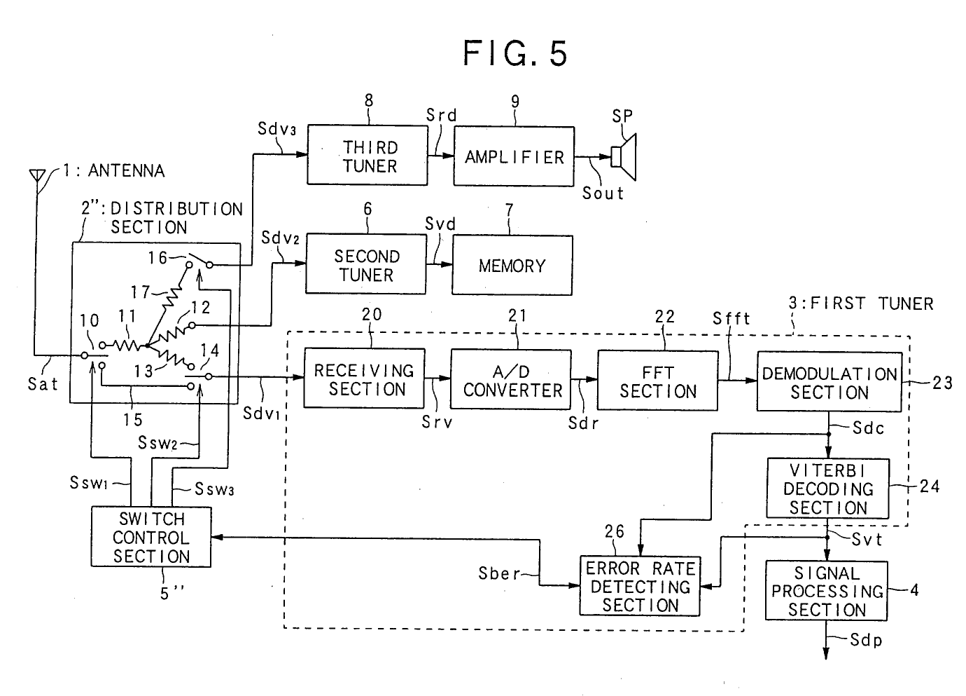

There will be explained below the third embodiment as another embodiment of the present invention with reference to FIG. 5.

FIG. 5 is a block diagram showing a schematic configuration of the receiving device of the third embodiment. Moreover, in FIG. 5, the same reference numerals are given to the same components as those of the receiving apparatus S1 according to the first embodiment shown in FIG. 1, and the description thereof is omitted.

The above first and second embodiments explained the case where the distribution destinations of the broadcasting signal Sat are two tuners, but in the third embodiment will explains the case where the distribution destinations of the broadcasting signal Sat are three tuners.

As shown in FIG. 5, similarly to the receiving apparatus S1 of the first embodiment, a receiving apparatus S3 of the third embodiment is composed of the antenna 1, the first tuner 3, the signal processing section 4, the second tuner 6, the memory 7, a distribution section 2″, a switch control section 5″, a third tuner 8, an amplifier 9 and a speaker SP.

In addition, the distribution section 2″ is composed of the switches 10 and 14, the resistors 11 through 13 and the connection line 15 which are the same as of the distribution section 2 of the first embodiment, and also a switch 16, and a resistor 17 having a preset resistance value.

There will be explained an operation.

In the following explanation about the operation, besides the broadcasting electronic wave as television broadcasting, the broadcasting electronic wave as data broadcasting and the broadcasting electronic wave as radio broadcasting are included in the broadcasting electronic wave to be received in the same frequency band.

At first, the antenna 1 receives a broadcasting electronic wave broadcasted based on the ISDB-T system and generates a broadcasting signal Sat to output it to the distribution section 2″.

The distribution section 2″ executes any one of a first distribution process, a second distribution process and a third distribution process based on switch control signals Ssw1, Ssw2 and Ssw3 from the switch control section 5. The first distribution process outputs the broadcasting signal Sat as the distribution signal Sdv1 only to the first tuner 3. The second distribution process outputs the broadcasting signal Sat as the distribution signal Sdv1 to the first tuner 3 and outputs the broadcasting signal Sat as the broadcasting signal Sdv2 to the second tuner 6. The third distribution process outputs the broadcasting signal Sat as the distribution signal Sdv1 to the first tuner 3, outputs the broadcasting signal Sat as the broadcasting signal Sdv2 to the second tuner 6, and outputs the broadcasting signal Sat as a distribution signal Sdv3 to the third tuner 8.

In the case where the first distribution process is executed, the switches 10 and 14 are turned to the side of the connection line 15 based on the switch control signals Ssw1 and Ssw2. As a result, the broadcasting signal Sat is directly output as the distribution signal Sdv1 directly to the first tuner 3.

Meanwhile, in the case where the second distribution process is executed, the switches 10 and 14 are turned to the sides of the resistors 11 and 13 respectively based on the switch control signals Ssw1 and Ssw2, and the switch 16 is turned off based on the switch control signal Ssw3. As a result, the broadcasting signal Sat is output as the distribution signals Sdv1 and Sdv2 to the first tuner 3 and the second tuner 6 respectively according to a distribution ratio corresponding to respective resistance values of the resistors 11 through 13.

On the other hand, in the case where the third distribution process is executed, the switches 10 and 14 are turned to the sides of the resistors 11 and 13 respectively based on the switch control signals Ssw1 and Ssw2, and the switch 16 is turned on based on the switch control signal Ssw3. As a result, the broadcasting signal Sat is output as the distribution signals Sdv1 through Sdv3 to the first tuner 3 and the second tuner 6 and the third tuner 8 respectively according to a distribution ratio corresponding to respective resistance values (normally, they are the same) of the resistors 11 through 13 and 17.

As a result, only in the case where the third distributing process is executed, the third tuner 8 extracts sound information corresponding to the radio broadcasting included in the distribution signal Sdv3, and gives a preset demodulation process to the extracted sound information, and generates a sound demodulation signal Srd to output it to the amplifier 9.

The demodulation process in the third tuner 8 is executed in the same frequency band as a demodulation process to be executed in the first tuner 3 or a demodulation process to be executed in the second tuner 6, which are mentioned later.

The amplifier 9 gives an amplifying process or the like to the sound demodulation signal Srd, and generates an output signal Sout to be output as a sound from the speaker SP so as to output the output signal Sout to the speaker SP.

As a result, the speaker SP releases the sound corresponding to the output signal Sout as radio broadcasting.

Next, only in the case where the second distribution process and the third distribution process are executed, the second tuner 6 and the memory 7 execute the same processes as the first embodiment, and store contents of the data information included in the data demodulation signal Svd.

The demodulation process in the second tuner 6 is executed in the same frequency band as the demodulation process to be executed in the first tuner 3.

On the other hand, in the case where the first distribution process through the third distribution process are executed, the first tuner 3 executes the same process as the first embodiment. Therefore, the first tuner 3 generates a decoding signal Svt to output it to the signal processing section 4, and generates a rate signal Sber to output it to the switch control section 5″.

As a result, the signal processing section 4 executes the same process as the first embodiment, and generates a processing signal Sdp so as to output it to the television device (not shown).

As a result, the switch control section 5″ generates the switch control signals Ssw1 through Ssw3 and outputs these signals to the switches 10, 14 and 16 so that the distribution section 2″ executes any one of the first through third distribution processes based on the rate signal Sber.

Next, there will be detailed below the distribution process in the distribution section 2″ based on the control process by means of the switch control section 5″ according to the third embodiment with reference to FIG. 5.

As mentioned above, the switch control section 5″ allows the distribution section 2″ to execute any one of the first through third distribution processes based on the rate signal Sber.

Namely, based on the rate signal Sber, when it is determined that BER shown by the rate signal Sber is less than a preset first threshold regardless of the carrier modulation system in the ISDB-T system, the switch control section 5″ generates the switch control signals Ssw1 through Ssw3 so as to output them to the switches 10, 14 and 16 so that the third distribution process is executed. In this case, even if the broadcasting signal Sat is distributed to all the first tuner 3, the second tuner 6 and the third tuner 8, the demodulation processes in the respective tuners can be normally executed.

Meanwhile, when it is determined that BER shown by the rate signal Sber is less than a second threshold, which is higher than the first threshold, and is not less than the first threshold, the switch control section 5″ generates the switch control signals Ssw1 through Ssw3 and outputs them to the switches 10, 14 and 16 so that the second distribution process is executed, and the broadcasting signal Sat is distributed only to the first tuner 3 and the second tuner 6. If the broadcasting signal Sat is distributed to all the first tuner 3, the second tuner 6 and the third tuner 8, the demodulation processes in the respective tuners cannot be normally executed.

However, if the broadcasting signal Sat is distributed only to the first tuner 3 and the second tuner 6, the demodulation processes in the first tuner 3 and the second tuner 6 can be normally executed.

Further, when it is determined that BER shown by the rate signal Sber is not less than the second threshold, the switch controls section 5″ generates the switch control signals Ssw1 through Ssw3 and outputs them to the switches 10, 14 and 16 so that the first distribution process is executed and the distribution signal Sat is distributed only to the first tuner 3. If the broadcasting signal Sat is distributed to all the first tuner 3, the second tuner 6 and the third tuner 8 and also if the broadcasting signal Sat is distributed only to the first tuner 3 and the second tuner 6, the demodulation processes in the respective tuners cannot be normally executed.

The first threshold is previously and experimentally obtained as the minimum value of BER in which in the case where the broadcasting signal Sat is distributed to all the first tuner 3, the second tuner 6 and the third tuner 8, all the normal demodulation processes in the respective tuners are impossible, but in the case where the broadcasting signal Sat is distributed to both the first tuner 3 and the second tuner 6, the normal demodulation processes are enabled. Moreover, the second threshold is previously and experimentally obtained as a minimum value of BER in which in the case where the broadcasting signal Sat is distributed to all the first tuner 3, the second tuner 6 and the third tuner 8, all the normal demodulation processes in the respective tuners are impossible, and in the case where the broadcasting signal Sat is distributed only to the first tuner 3 and the second tuner 6, the normal demodulation processes are impossible, but in the case where the broadcasting signal Sat is distributed only to the first tuner 3, the normal demodulation process in this tuner is enabled.

As explained above, according to the distribution processes in the receiving apparatus S3 of the third embodiment, it is determined on the basis of the receiving state of the broadcasting electronic wave which distribution process in three tuners is executed (namely, a number of distribution destinations). Therefore, in comparison with the case where the broadcasting signal Sat is always distributed to all the tuners, the receiving processes in the respective tuners can be prevented from being impossible due to deterioration of the receiving state. Moreover, the receiving process in the first tuner 3 is enabled even in the inferior receiving state of the broadcasting electronic wave.

In addition, the actual BER is compared with the preset first threshold and second threshold and the form of the distribution process is determined so that the distribution process can be executed simply and securely.

Further, the form of the distribution process is determined based on the priorities preset in the respective tuners (in the third embodiment, the first tuner 3 has a higher priority than the second tuner 6, and the second tuner 6 is a higher priority than the third tuner 8). Therefore, the distribution destinations of the broadcasting signal Sat can be determined efficiently and effectively based on the priorities.

Furthermore, when the detected actual BER is not less than the second threshold, the broadcasting signal Sat is distributed only to the first tuner 3. Therefore, the demodulation process in the first tuner 3 can be executed securely.

In addition, when the detected actual BER is not less than the first threshold but less than the second threshold, the broadcasting signal Sat is distributed only to the first tuner 3 and the second tuner 6, the demodulation processes in the first tuner 3 and the second tuner 6 can be executed securely.

Further, since the broadcasting signal Sat is distributed only to the first tuner 3 only via the connection line 15 excluding the resistors, loss of the broadcasting signal Sat in the resistors is small, and the broadcasting electronic wave can be received continuously in the good receiving state.

(IV) Modified Embodiment

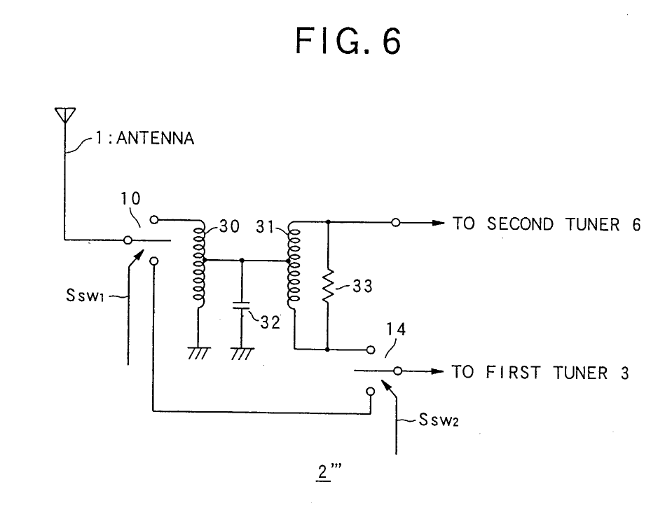

There will be explained below another embodiment of the present invention with reference to FIG. 6.

FIG. 6 is a circuit block diagram showing a configuration of a distribution section according to the modified embodiment.

The aforementioned embodiments explained the case where so-called resistance distribution type distribution section is used, but as the distribution section in these embodiments, a so-called hybrid type distribution section shown in FIG. 6 can be also used.

Namely, the hybrid type distribution section 2″ in which the same switches 10 and 14 as the first embodiment, for example, coils 30 and 31, a capacitor 32 and a resistor 33 are connected as shown in FIG. 6, is used and the broadcasting signal Sat is distributed to the respective tuners in the respective embodiments.

In addition, the aforementioned embodiments explained the case where television broadcasting or the like transmitted via a broadcasting electronic wave is received by the antenna 1. However, besides this, television broadcasting or the like distributed by using a cable television line or an internet line is received by terminal devices only for the respective lines, and the corresponding broadcasting signal Sat can be generated.

Further, the third embodiment described the case where the tuners which execute the demodulation processes are three. However, besides this, the present invention can be applied to the case where four or more tuners are prioritized and the broadcasting signal Sat is distributed thereto.

In this case, impedance matching should be obtained between transmission paths to the tuners according to the number of distribution so that an attenuation value of a signal level of the broadcasting signal Sat becomes minimum. More concretely, for example, in the case of resistance type distribution section, resistance values of the resistors are variable according to the distribution number so that the broadcasting signal Sat can be distributed with small attenuation value.

In addition, the aforementioned embodiments and modified embodiment explained the case where the form of the distribution of the broadcasting signal Sat is determined by using the BER, the AGC voltage or the C/N ratio. However, besides this, the form of the distribution may be determined by using another information included as the control information in the TMCC signal, namely, time interleave length information, segment number information or form discriminating flag. Further, the form of the distribution may be determined on the basis of another control information in the ISDB-T system, namely, mode information, SP (scattered pilot) information, CP (continual pilot) information, AC1 (Auxiliary channel 1) information, AC2 (Auxiliary channel 2) information, guard interval length information or so-called S meter value or the like. Such control information may be used in order to evaluate an actual receiving condition, as shown in the embodiments.

The entire disclosures of Japanese Patent Application No. 2000-237236 filed on Aug. 4, 2000 and Japanese Patent Application Laid-Open No. 11-177642 published on Jul. 2, 1999 including the specification, claims, drawings and summary are incorporated herein by reference in its entirety.

1. A broadcasting signal processing apparatus, comprising:
a plurality of signal processing devices for giving a predetermined process to a broadcasting signal;
a distributing device for distributing the broadcasting signal obtained from outside to at least one of said plurality of signal processing devices;
a detecting device for detecting an obtaining state of the broadcasting; and
a determining device for controlling the distributing device and for determining at least one of said plurality of signal processing devices based on the detected obtaining state.

2. The broadcasting signal processing apparatus according to claim 1, wherein the determining device compares the obtaining state of the broadcasting with a predetermined value, which is a threshold value to change the number of signal processing devices, to which the broadcasting signal is distributed by the distributing devices.

3. The broadcasting signal processing apparatus according to claim 1, wherein the determining device determines at least one of said plurality of signal processing devices further based on an order of priority in the plurality of signal processing devices.

4. The broadcasting signal processing apparatus according to claim 2, wherein the determining device determines at least one of said plurality of signal processing devices further based on an order of priority in the plurality of signal processing devices.

5. A broadcasting signal processing apparatus, comprising:
a plurality of signal processing devices for giving a preset process to a broadcasting signal;
a distributing device for distributing the broadcasting signal obtained from outside to at least one of said plurality of signal processing devices;
a detecting device for detecting an obtaining state of the broadcasting; and
a determining device for controlling the distributing device and for determining the number of the signal processing devices, to which the broadcasting signal is distributed by the distributing device.

6. The broadcasting signal processing apparatus according to claim 5, wherein the determining device compares the obtaining state of the broadcasting with a predetermined value, which is a threshold value to change the number of signal processing devices.

7. The broadcasting signal processing apparatus according to claim 5, wherein the determining device determines the number of the signal processing devices, further based on an order of priority in the plurality of signal processing devices.

8. The broadcasting signal processing apparatus according to claim 6, wherein the determining device determines the number of the signal processing devices, further based on an order of priority in the plurality of signal processing devices.

9. The broadcasting signal processing apparatus according to claim 5, wherein the distributing device distributes the broadcasting signal while obtaining impedance matching according to the number of the signal processing devices.

10. The broadcasting signal processing apparatus according to claim 1, wherein when the obtaining state is worse obtaining state than a predetermined level, the determining device determines only one of said plurality of signal processing devices so that distributing device distributes the broadcasting signal only to the one of said plurality of signal processing devices.

11. The broadcasting signal processing apparatus according to claim 5, wherein when the obtaining state is worse obtaining state than a predetermined level, the determining device determines only one of said plurality signal processing devices so that the distributing device distributes the broadcasting signal only to the one of said plurality of signal processing devices.

12. The broadcasting signal processing apparatus according to claim 1, wherein the predetermined process includes a receiving process of the broadcasting signal, and the obtaining state is at least any one of a receiving electric power of the broadcasting signal, an error rate in the broadcasting signal, and a C/N ratio of the broadcasting signal.

13. The broadcasting signal processing apparatus according to claim 5, wherein the preset process is a receiving process of the broadcasting signal, and the obtaining state is at least any one of a receiving electric power of the broadcasting signal, an error rate in the broadcasting signal, and a C/N ratio of the broadcasting signal.

14. The broadcasting signal processing apparatus according to claim 1, wherein the broadcasting is obtained via at least any one of a broadcasting electronic wave, a cable television line, and an internet line.

15. The broadcasting signal processing apparatus according to claim 5, wherein the broadcasting is obtained via at least any one of a broadcasting electronic wave, a cable television line, and an internet line.
